(19) United States
(12) Patent Application Publication
(10) Pub. No.: US 2019/0122054 A1
(43) Pub. Date: Apr. 25, 2019

(54) ROAD RECOGNITION APPARATUS

(71) Applicant: DENSO CORPORATION, Kariya-city (JP)

(72) Inventors: Shunya KUMANO, Nisshin-city (JP); Shunsuke SUZUKI, Kariya-city (JP)

(21) Appl. No.: 16/166,526

(22) Filed: Oct. 22, 2018

(30) Foreign Application Priority Data
Oct. 23, 2017 (JP) 2017-204429

(51) Int. Cl. G06K 9/00; B60W 40/076; B60W 10/20; B60W 20/15; G08G 1/16; B60W 40/072

(52) U.S. Cl. CPC G06K 9/00798; B60W 40/076; B60W 10/20; B60W 2550/142; G08G 1/166; B60W 40/072; B60W 2420/42; B60W 20/15

(57) ABSTRACT

A road recognition apparatus is provided to determine a change in slope of the road by using a position of the preceding vehicle in a captured image. The road recognition apparatus detects a lower end portion of the preceding vehicle in the captured image. The road recognition apparatus calculates an estimated position where the lower end portion is expected to be present when assuming that the slope of the road is constant. The road recognition apparatus determines whether a difference between the detected lower end portion and the estimated position in the up-down direction exceeds a predetermined threshold. The road recognition apparatus determines that the road change point of the road is present when determined that the difference exceeds the predetermined threshold.

### CROSS-REFERENCE TO RELATED APPLICATION

This application is based on and claims the benefit of priority from earlier Japanese Patent Application No. 2017-204429 filed Oct. 23, 2017, the description of which is incorporated herein by reference.

### BACKGROUND

### Technical Field

The present disclosure relates to a road recognition apparatus.

### Description of the Related Art

Recently, a road recognition apparatus is known in which a change in slope of the road is determined by using an image captured by an on-board camera. For example, Japanese Patent Application Laid-Open Publication No. 2014-232439 proposes an image processing apparatus in which a plurality of horizontal lines are set in the up-down direction in the captured image to secure a plurality of horizontal regions in the captured image, and a change in slope of the road is determined based on position of the vanishing point detected in each horizontal region. The vanishing point is detected in accordance with a road end or a lane marking detected in the horizontal regions.

In the case where a vehicle is travelling, a preceding vehicle travels in the same lane where the vehicle is running. In this case, the road end or a part of lane marking in the captured image may be hidden by the preceding vehicle.

### SUMMARY

One aspect of the present disclosure provides a road recognition apparatus that determines a change in slope of the road by utilizing a position of the preceding vehicle in the captured image.

As one aspect of the present disclosure, a road recognition apparatus is provided with a detecting unit, a calculation unit and a determination unit. The detecting unit is configured to detect a first position which is a position of a preceding vehicle in a captured image obtained by a camera mounted on a vehicle capturing ahead of a vehicle including a road. The calculation unit is configured to calculate a second position which is expected to be a position of the preceding vehicle in the captured image when assuming a slope of the road is constant. The determination unit is configured to determine a change in the slope of the road by comparing the first position and the second position in the captured image.

According to the above-mentioned configuration, a slope change of the road can be determined by utilizing the position of the preceding vehicle in the captured image.

### BRIEF DESCRIPTION OF THE DRAWINGS

In the accompanying drawings:

FIG. 1 is a block diagram showing a configuration of a vehicle according to a first embodiment of the present disclosure;

FIG. 2 is a diagram showing a position of a camera according to the first embodiment;

FIG. 3 is a flowchart showing a determination process of the first embodiment;

FIG. 4 is a diagram showing an example of a captured image;

FIG. 5 is an explanatory diagram showing a positional relationship between a vehicle and a preceding vehicle according to the first embodiment;

FIG. 6 is a diagram showing an example of a branched road having a slope;

FIG. 7 is a flowchart showing a determination process according to a second embodiment;

FIG. 8 is a flowchart showing a determination process according to a first modification;

FIG. 9 is a diagram showing an image of a road having falling slope according to a second modification;

FIG. 10 is a diagram showing an image of a curved road according to the second modification;

FIG. 11 is a diagram showing a trajectory of a preceding vehicle and a road shape according to the second modification;

FIG. 12 is a flowchart showing a determination process according to the second modification;

FIG. 13 is a diagram showing a vanishing point of a road having falling slope according to a third embodiment; and

FIG. 14 is a diagram showing a vanishing point of a road having rising slope according to the third embodiment.

### DETAILED DESCRIPTION OF PREFERRED EMBODIMENTS

Hereinafter, with reference to the drawings, embodiments of the present disclosure will be described. Reference signs used for in the following embodiments are also used for claims. However, the reference signs are used for the sake of readily understanding the present disclosure and do not limit the interpretation of the scope of claims.

### First Embodiment

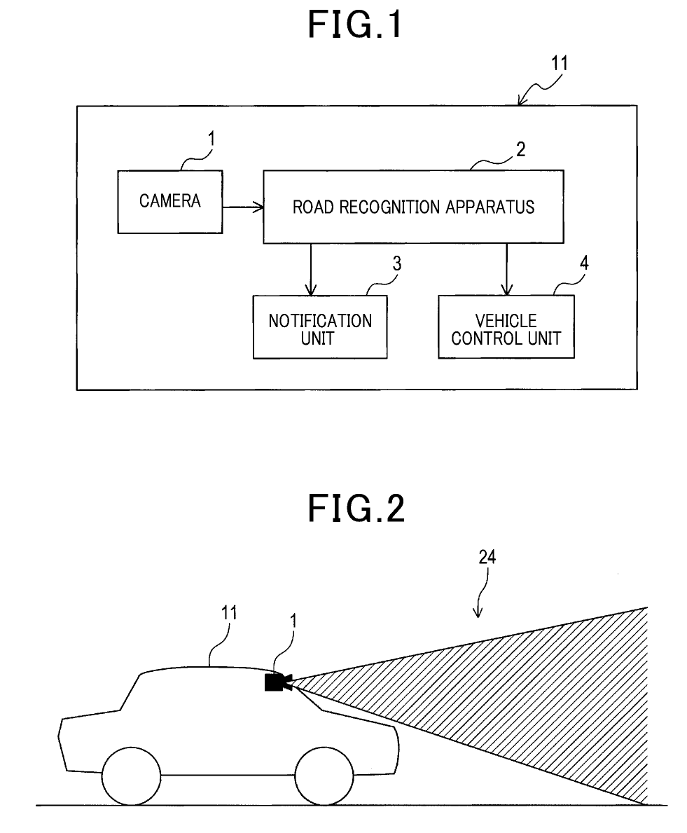

The configuration of the first embodiment will be described. A vehicle 11 shown in FIG. 1 is provided with a camera 1, a road recognition apparatus 2, a notification unit 3 and a vehicle control unit 4.

The camera 11 captures an area including the road ahead of the vehicle 11. The camera 1 captures an image at a certain period to obtain a captured image and outputs data of the captured image to the road recognition apparatus 2. As shown in FIG. 2, the camera 1 is attached to an upper portion in the front center of the vehicle 11. In this example, the camera 1 is attached to a back side of a rearview mirror. Hence, when the road slope is constant, in the captured image, the upper end of the preceding vehicle travelling ahead of the vehicle 11 and the vanishing point in the captured image are positioned at approximately the same point in the up-down direction.

The road recognition apparatus 2 is an electronic control unit included in the vehicle. The road recognition apparatus 2 is mainly configured as a known microcomputer provided with CPU and semiconductor memory devices such as RAM, ROM and Flash memory. The function of the road recognition apparatus 2 is accomplished by having CPU execute a program stored in a non-transitory tangible recording media. In this example, the semiconductor memory devices correspond to the non-transitory tangible recoding media in which the program is stored. The road recognition program 2 executes the program, whereby a recognition process and a determination program, which will be described later, are executed. The number of microcomputers is not limited to one. However, a plurality of microcomputers may be used.

The road recognition apparatus 2 determines a change in slope (hereinafter referred to as slope change) of the road where the vehicle 11 travels, using a captured image sent from the camera 1. Detailed determination method of the slope change will be described in a section of the determination process. The road recognition apparatus 2 recognizes lane markings which are markings on both side of the road where the vehicle travels. Specifically, the road recognition apparatus 2 detects, in the captured image, road paint drawn on the road. Then, the road recognition apparatus 2 calculates a marking parameter that indicates a shape of the lane marking based on the road paint, thereby recognizing the lane marking. The road recognition apparatus 2 transmits the calculated marking parameter to the notification unit 3 and the vehicle control unit 4. Note that the markings refer to various lines which divides the road where the vehicles travels, the color of the line being for example white or yellow, and the shape of the line being a solid line or a dotted line.

Here, a relationship between the determination process of the slope change and the recognition process of the lane marking will be described. When the determination process determines that a slope change point of the road is present while the vehicle 11 is travelling on the road having constant slope, the road recognition apparatus 2 reflects the determination result on the recognition process. Specifically, the road recognition apparatus 2 does not use an upper region located at upper side of the slope change point in the captured image when it is determined that the slope change point is present. In other words, the road recognition apparatus 2 only uses a lower region in the captured image, located lower than the slop change point is.

The notification unit 3 is configured as an integrated unit including necessary units that notify the driver on the vehicle 11 of information regarding processes such as recognition process. The notification unit 3 notifies the driver on the vehicle 11 of the vehicle 11 being departed from the lane marking with a sound or light, when determines that the vehicle 11 has departed from the lane marking.

The vehicle control unit 4 performs various traveling controls of the vehicle 11 such as an automatic steering operation in order to avoid lane departure based on the marking parameter transmitted from the road recognition apparatus 2.

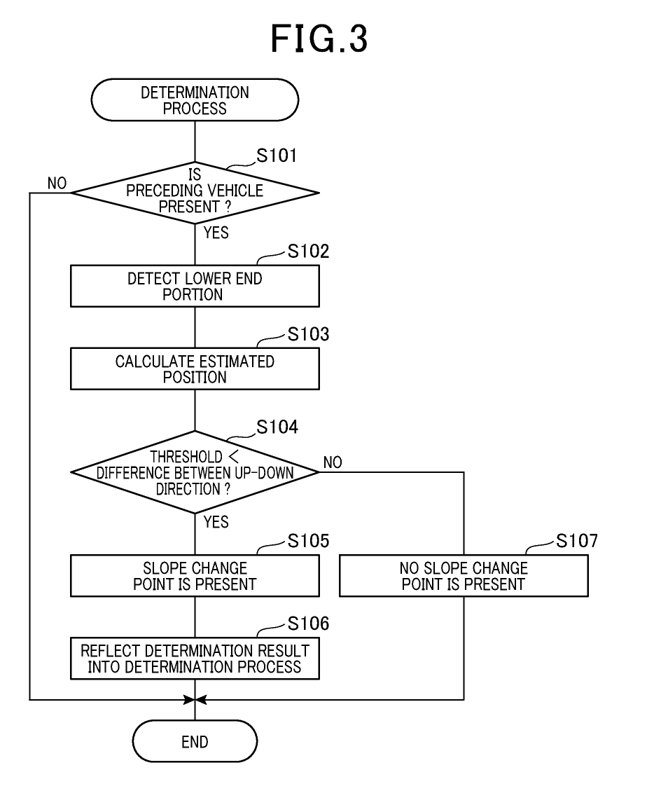

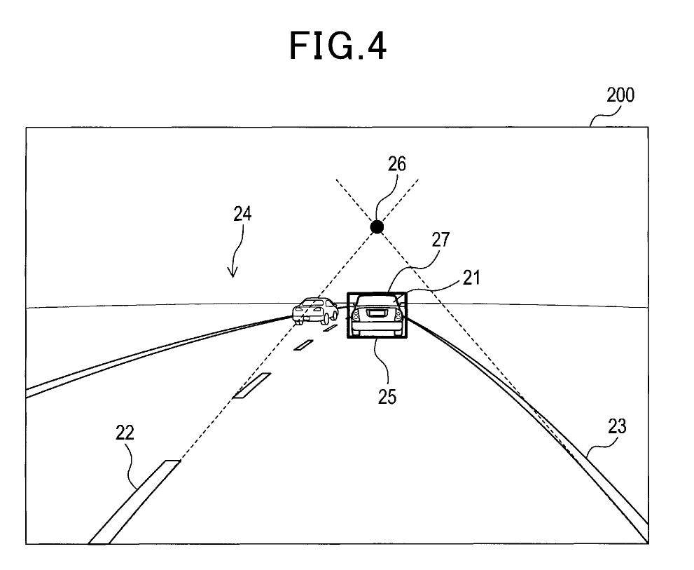

Next, with reference to a flowchart shown in FIG. 3, a procedure of a determination process executed by the road recognition apparatus 2 will be described. The determination process is executed by the road recognition apparatus 2 every time when the captured image is received from the camera 1. The captured image 200 shown in FIG. 4 is an example of an image transmitted to the road recognition apparatus 2 from the camera 1. In the captured image 200, the road 24 ahead of the vehicle 11 is captured including the preceding vehicle 21 and the lane markings 22 and 23.

At S101, the road recognition apparatus 2 determines whether a preceding vehicle is present in the captured image. The determination of whether the preceding vehicle is present is performed by a known template matching using HOG (histograms of oriented gradients) feature quantity, for example. According to an example shown in FIG. 4, it is determined that the preceding vehicle 21 is present in the captured image.

The road recognition apparatus 2 proceeds to step S102 when determined that a preceding vehicle is present at step 101. On the other hand, the road recognition apparatus 2 terminates the determination process when determined that no preceding vehicle is present at step S101.

At S102, the road recognition apparatus 2 detects a lower end portion of the preceding vehicle in the captured image. According to an example shown in FIG. 4, a lower end portion 25 of the preceding vehicle 21 is detected. At step S103, the road recognition apparatus 2 calculates an estimated portion in which a lower end portion of the preceding vehicle is estimated to be present, when assuming that the road slope is constant. According to the present embodiment, the estimated portion is calculated based on an estimated value of the intervehicle distance up to the preceding vehicle calculated by the past captured image.

On the assumption that the road slope is constant in the captured image, the road recognition apparatus 2 calculates a calculated intervehicle distance as an intervehicle distance up to the preceding vehicle. The calculated intervehicle distance is calculated by identifying the location of the vanishing point and the lower end portion of the preceding vehicle in the captured image. This is because, since it is evident from the known perspective projection transformation, when identifying the position of the vanishing point in the captured image, a correlation between the lower end portion of the preceding vehicle in the captured image and the intervehicle distance up to the preceding vehicle is identified. The vanishing point is identified as a crossing point of linear lines extended from the lower end portions of the left-right lane markings. In other words, the apparatus utilizes a vanishing point when assuming that the road slope is constant. In the case where a part of left-right lane markings cannot be used because of obstacles or a branched road, the latest vanishing point which has been identified is used.

Then, the road recognition apparatus 2 calculates, based on the calculated intervehicle distance at a time of capturing a past image, an estimated intervehicle distance which is an estimated value of an intervehicle distance to the preceding vehicle when the latest image was captured. The estimated intervehicle distance is calculated based on a change in the calculated intervehicle distance over time among the latest capturing times, for example.

Here, calculation methods of calculating the calculated intervehicle distance and the estimated intervehicle distance for a case where the captured image 200 is a past image. First, the vanishing point 26 is identified as a crossing point of linear lines extended from the lower end portions of the left-right lane markings 22 and 23 of the road 24 in the past captured image 200. Next, the calculated intervehicle distance between the vehicle 11 and the preceding vehicle 21 is calculated based on the lower end portion 25 and the vanishing point 26. Then, the estimated intervehicle distance is calculated based on a change in the calculated. Then, a change in the calculated intervehicle distance over time among the latest capturing times including the captured image 200.

Next, the road recognition apparatus 2 calculates the estimated portion of the preceding vehicle in the latest captured image based on the estimated intervehicle distance. The estimated portion is calculated based on the above-described correlation, using the estimated intervehicle distance and location of the vanishing point in the latest captured image. When the captured image 200 shown in FIG. 4 is the latest image, the estimated portion is calculated based on the estimated intervehicle distance and the vanishing point 26.

At step S104, the road recognition apparatus 2 determines, in the captured image, whether a difference of positions between the lower end portion detected at step S102 and the estimated portion calculated at step S103 of the preceding vehicle in the up-down direction exceeds a threshold. When the road recognition apparatus 2 determines that the difference exceeds the threshold, the road recognition apparatus 2 determines, at step S105, that a slope change point of the road is present and proceeds to step S106. According to the example shown in FIG. 4, in the captured image 200, it is determined that the difference of positions between the lower end portion 25 and the estimated portion of the preceding vehicle 21 in the up-down direction exceeds the threshold.

At step S106, the road recognition apparatus 2 reflects a determination result that the slope change point is present into a recognition process of the lane marking. Specifically, the road recognition apparatus 2 regards the lower end portion of the preceding vehicle in the captured image to be the slope change point, and does not use an upper region located in the upper side of the slope change point but uses a lower region located in the lower side of the lower side of the slope change point. After executing the process at step S106, the road recognition apparatus 2 terminates the determination process. In the example shown in FIG. 4, a region located in the upper side of the lower end portion 25 is not used for the recognition process of the lane marking but uses a region located in the lower side of the lower end portion 25 for the recognition process.

On the other hand, when it is determined at step S104 that the difference of positions between the lower end portion and the estimated portion of the preceding vehicle in the up-down direction exceeds a threshold, the road recognition apparatus 2 proceeds to step S107. At step S107, the road recognition apparatus 2 determines that no slope change point of the road is present and terminates the process.

According to the first embodiment, the following effects and advantages are obtained.

The road recognition apparatus 2 determines in the captured image whether a slope change point of the road is present based on a difference between the lower end portion and the estimated portion of the preceding vehicle in the up-down direction.

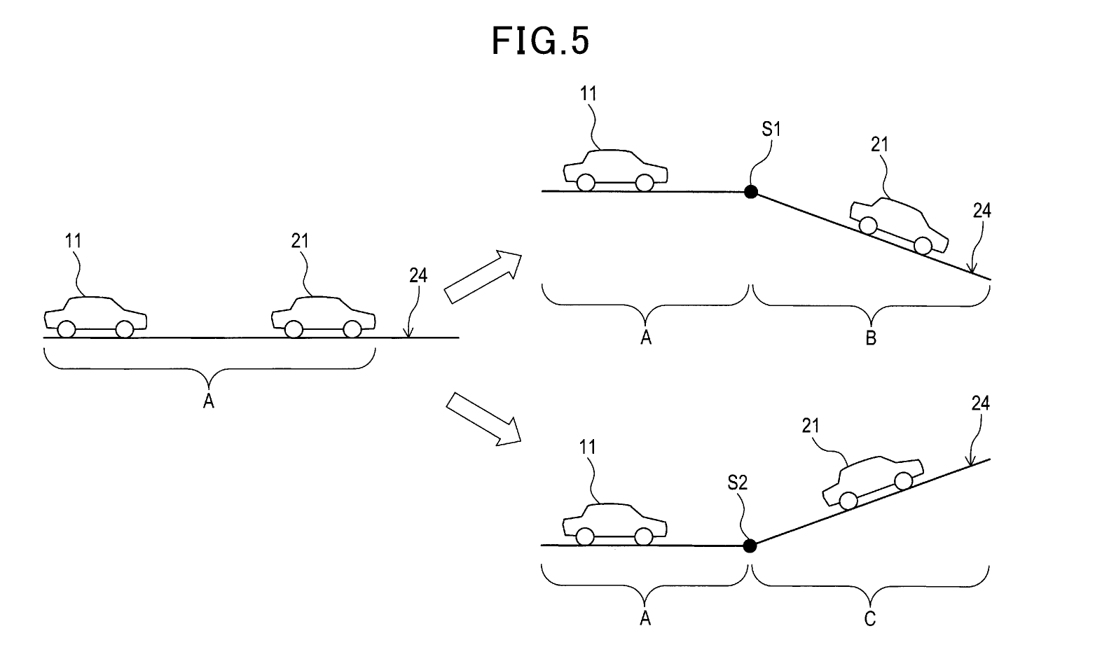

For example, as shown in FIG. 5, it is assumed that the vehicle 11 and the preceding vehicle 21 are travelling on the road 24. In the case where the vehicle 11 and the preceding vehicle 21 are travelling in a flat region A having constant slope, the lower end portion of the preceding vehicle 21 in the captured image becomes close to or the same as the estimated portion where the lower end of the preceding vehicle 21 is estimated to present, when assuming that road slope is constant. Meanwhile, when the vehicle 11 is still travelling in the region A, and the preceding vehicle 21 is travelling in the region B having downslope after passing a slope change point S1, the lower end portion of the preceding vehicle 21 in the captured image is shifted downward than the estimated portion is. In the case where the vehicle 11 is still travelling in the region A and the preceding vehicle 21 is travelling in the region C having upslope, the lower end portion of the preceding vehicle 21 in the captured image is shifted upward than the estimated portion is.

Hence, the determination process of the present embodiment calculates the difference between the lower end portion and the estimated portion of the preceding vehicle in the captured image, thereby determining the slope change of the road. According to the present embodiment, the slope change is determined based on only the captured image.

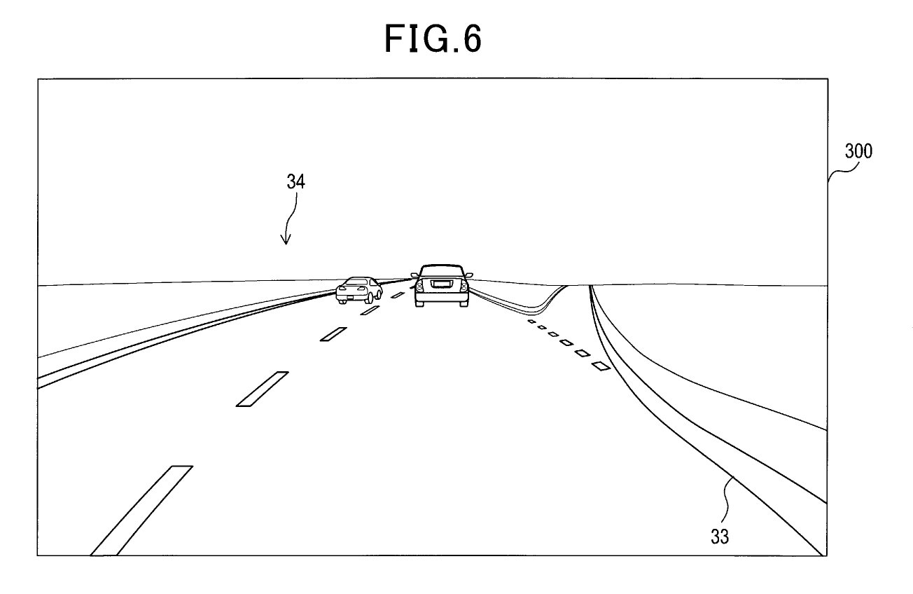

According to the configuration of the present embodiment, even in a state of road where a part of left-right lane markings cannot be used so that vanishing points cannot be identified, the slope change can be determined based on the captured image only. For example, as shown a captured image 300 in FIG. 6, in the case where a branch road is present on the extended line of a lane marking 33 in the right-side, and when determining a slope change of the road 34 without using the right-side lane marking 33 for determining vanishing points in the captured image, the vanishing points cannot be identified. In this case, the road recognition apparatus 2 of the present disclosure uses the latest vanishing points which have been identified. Hence, according to the present embodiment, a slope change can be identified even for a branched road having a slope.

The road recognition apparatus 2 performs a recognition process using a lower side region than the slope change point being located in the captured image, when slope change points are present in the road. Therefore, according to this configuration, erroneous determination of lane marking in the recognition process is unlikely to occur.

According to the first embodiment, the lower end portion of the preceding vehicle corresponds to a first portion and the estimated portion corresponds to a second portion. Also, step S102 corresponds to a process of a detecting unit, step S103 corresponds to a process of a calculation unit, steps S104, S105, S107 corresponds to processes of a determination unit, and step S106 corresponds to a recognition unit.

### Second Embodiment

According to the second embodiment, the basic configuration is the same as that of the first embodiment, but the determination process is different from the first embodiment. Hence, a portion different from the first embodiment will be mainly described.

As described, the camera 1 is mounted to the vehicle such that in the captured image, the upper end of the preceding vehicle and the vanishing point in the captured image are located at approximately the same position in the up-down direction when the slope of the road is constant. Hence, for example, as shown in FIG. 5, in the case where the vehicle 11 is traveling in the region A and the preceding vehicle 21 is traveling in the region B having downslope after passing through the slope change point S1, in the captured image, the upper end of the preceding vehicle is shifted downward with respect to the vanishing point. Focusing on this point, according to the determination process of the second embodiment, it is determined whether the slope change point of the road is present based on a comparison between the upper end portion of the preceding vehicle and the vanishing point in the captured image.

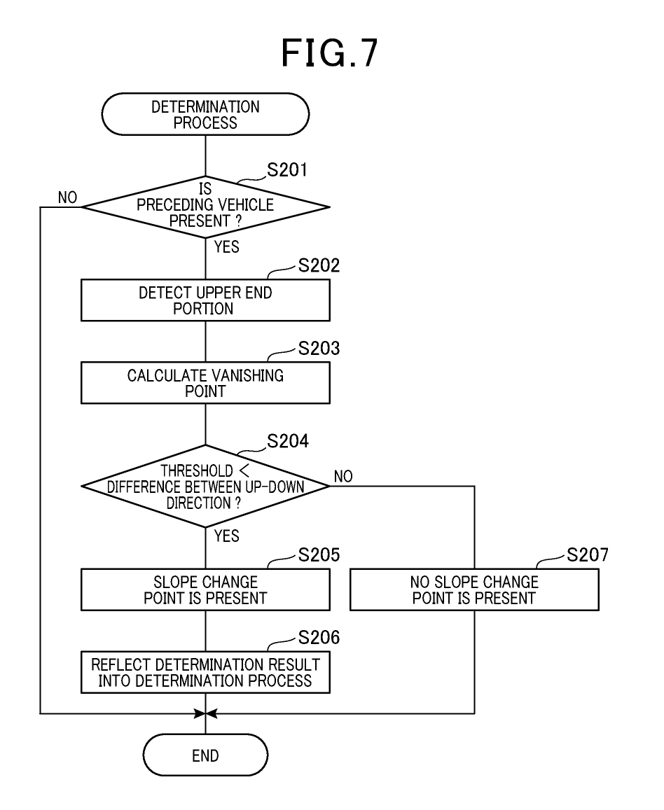

With reference to the flowchart shown in FIG. 7, a determination process according to the second embodiment will be described.

The process at step S201 is similar to that of step S101. At S202, the road recognition apparatus 2 detects the upper end portion of the preceding vehicle in the captured image. According to an example shown in FIG. 4, the upper end portion of the preceding vehicle 21 is detected.

At S203, the road recognition apparatus 2 identifies the vanishing point in the captured image using a method similar to the process of step S103. According to an example shown in FIG. 4, the vanishing point 26 is identified. Also, in the process of step S203, similar to the step of step S103, the latest vanishing point is used if no vanishing points have been identified.

At step S204, the road recognition apparatus 2 determines, in the captured image, whether a difference between the upper end portion of the preceding vehicle calculated at step S202 and the vanishing point calculated at step S203 in the up-down direction exceeds a threshold. When determined that the difference exceeds the threshold, the road recognition apparatus 2 proceeds to the step S205. Note that the processes at steps S205 and S206 are similar to those of steps S105 and S106.

On the other hand, when it is determined, in the captured image, that the difference between the upper end portion and the vanishing point in the up-down direction does not exceed the threshold, the road recognition apparatus 2 proceeds to step S207. The process of step S207 is the same as that of step S107. Thus, according to the determination process of the second embodiment, similar to the determination process of the first embodiment, the slope change can be determined based on only the captured image.

Note that the upper end portion of the preceding vehicle corresponds to a first position and the vanishing point corresponds to a second position. The process of step S202 corresponds to a process of a detecting unit, the process of step S203 corresponds to a calculation unit, processes of steps S204, S205 and S207 correspond to a determination unit, and a process of step S206 corresponds to a process of a recognition unit. As described, embodiments of the present disclosure are described. The above-described embodiments are not limited thereto and various modifications can be made.

### Other Embodiments

According to the above-described embodiments, as a process after the road recognition unit determines whether a slope change point is present, a process is exemplified in which an upper region located in an upper side than the slope change point in the captured image is not used. However, these processes are not limited thereto.

For example, a whole captured image in which it has been determined that a slope point is present may not be used for a recognition process. Also, for example, depending on a situation of the road, as a region which is not used for the recognition process, either a whole region or an upper region located in the upper side of the slope point may be used. Further, information notifying a present of the slope change point may be inputted to the vehicle control unit. In this case, the vehicle control unit to which the information is inputted may be configured to determine whether a marking parameter calculated based on the captured image having a slope change point is used for a control of the vehicle 11.

According to the determination process, the apparatus may be configured to determine that the slope change point is present when the difference between the lower end portion and the estimated position of the preceding vehicle in the up-down direction continuously exceeds the threshold.

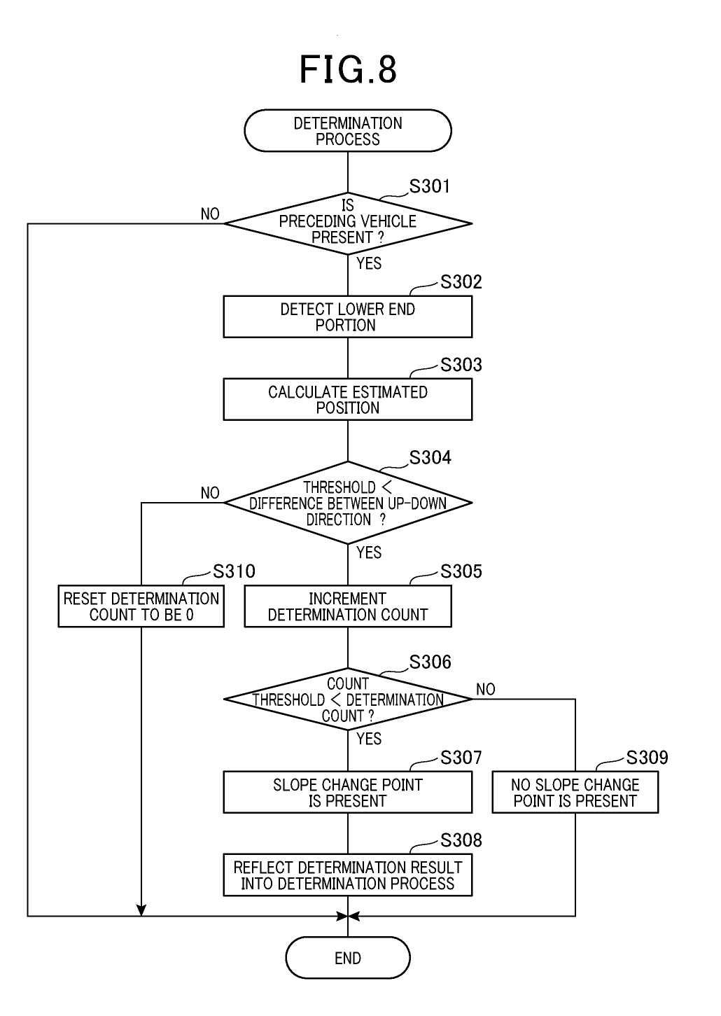

For example, compared to the determination process of the first embodiment, a determination process of a first modification shown in FIG. 8 further includes processes of steps S305, S306 and S310 which counts the number of counts in which the difference of positions in the up-down direction continuously exceeds the threshold. In other words, the processes of steps S301 to S304, S307 to S309 are similar to steps S101 to S107. Hence, explanations for processes of steps S301 to S304, and S307 to S309 will be omitted.

When it is determined, at step S304, that the difference in the up-down direction exceeds the threshold, the road recognition apparatus 2 increments the determination count at step S305, and proceeds to step S306. At step S306, the road recognition apparatus 2 determines whether the determination count exceeds a predetermined count threshold. The count threshold refers to a frequency where the difference in the up-down direction continuously exceeds the threshold in order to determine where the slope change point is present. When it is determined that the determination count exceeds the count threshold, the road determination apparatus 2 proceeds to step S307. When determined that the determination count exceeds the count threshold, the road recognition apparatus 2 proceeds to step S307. On the other hand, when it is determined that the determination count does not exceed the count threshold, the road recognition apparatus 2 proceeds to step S309. Note that the value of the determination count is held till the next determination count process.

Meanwhile, when it is determined that the difference in the up-down direction does not exceed the threshold at step S304, the road recognition apparatus 2 resets the determination count to be 0 at step S310 and terminates the determination process. According to such a configuration, in the case where probability of presence of the slope change point in a plurality of captured images is high, presence of the slope change point can be determined. As a result, the determination of a change in the slope can be determined with constant likelihood. In the processes of steps S302 to S304, instead of using the difference in the up-down direction between the lower end portion and the estimated portion of the preceding vehicle, the process may determine whether a difference in the up-down direction between the upper end portion and the vanishing point of the preceding vehicle exceeds the threshold.

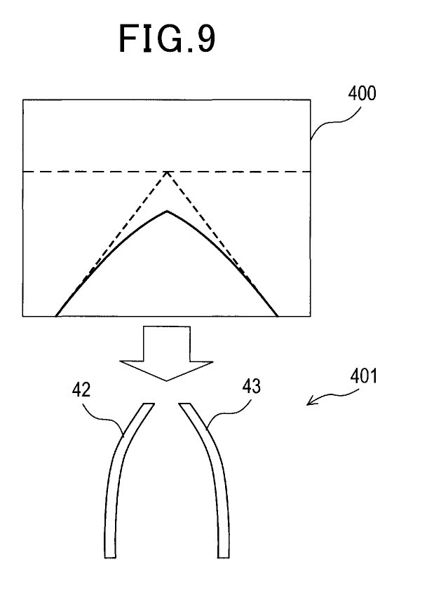

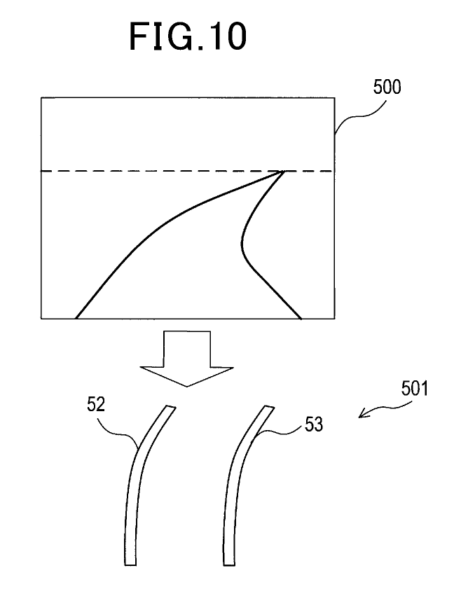

Further, the determination process may determine whether a shape of the lane marking and the locus of the preceding vehicle in the top view image are different from each other, and may determine the slope change. The top view image refers to an image in which captured image is converted to an image viewed from the right above the vehicle. Specifically, for example, the captured image 400 shown in FIG. 9 has captured a road in which the slope changes from a flat slope region having a constant slope to a downslope region. The captured image 500 shown in FIG. 10 has captured a road in which the slope changes from a flat slope region having a constant slope extending straightforward to a right-curved region. The top view image 401 refers to an image in which the captured image 400 is converted to an image viewed from the right above the vehicle. Similarly, the top view image 501 refers to an image in which the captured image 500 is converted to an image viewed from the right above the vehicle.

The image conversion from the captured image to the top view image is executed based on the vanishing point of the captured image assuming the road is flat having a constant slope. Then, when converting a captured image capturing a region in which the slope changes like the captured image 400 into a top view image, a region having a slope change is distorted. As a result, each of the left-right lane markings 42 and 43 which should be linear shape, is depicted by a curved shape curved towards the center in the top view image 401. Therefore, the shape of the left lane marking 42 in the top view image 401 is similar to the shape of the right curved lane markings 52 and 53 in the top view image 501.

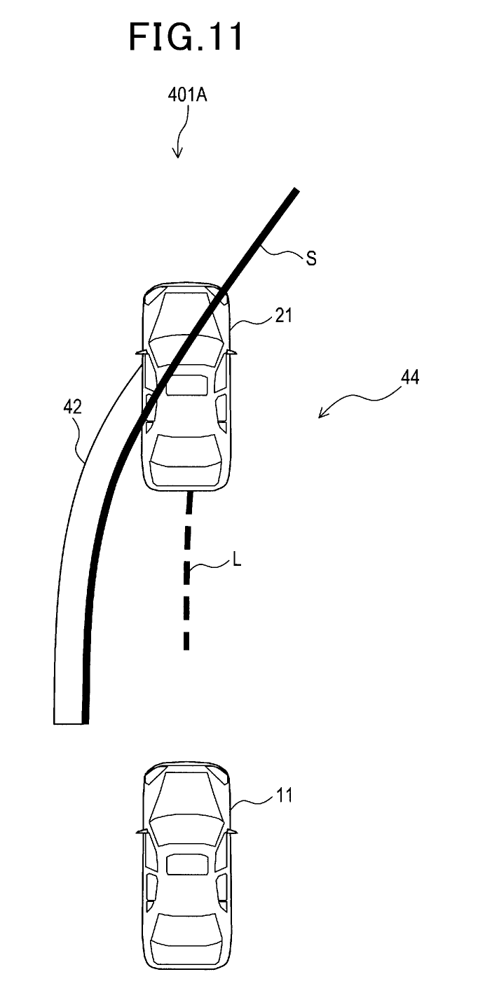

Considering the above-mentioned assumption, for example, in the case where the lane marking 43 is not recognized but only the lane marking 42 is recognized and shown in the top view image 401, it is difficult to determine whether the road changes from a flat road having a constant slope to a downslope road. However, even in this case, the shape of the lane marking and the locus of the preceding vehicle in the top view image are compared, whereby it can be determined whether the road has a slope change. For example, a virtual image 401A shown in FIG. 11 is a virtual image in which virtual vehicles of the vehicle 11 and the preceding vehicle 21 when viewed from the right above the vehicle are overlapped on the lane marking 42 of the top view image 401. The preceding vehicle 21 is assumed to travel straight forward in the actual road from a flat region having constant slope to a downslope region passing the slope change point. In this case, as shown in FIG. 11, when it is assumed that the locus L of the preceding vehicle 21 is depicted in the virtual image 401A, the locus L has a linear shape. On the other hand, the shape of the lane marking 42, that is, the shape of the inner edge S of the lane marking 42 in this example has a right-curved shape.

Focusing on this point, according to the determination process in this example, in addition to the difference between the lower end portion and the estimated portion of the preceding vehicle in the up-down direction, a difference of the shapes between the lane marking and the locus of the preceding vehicle in the top view image is calculated, thereby determining whether a slope change point is present.

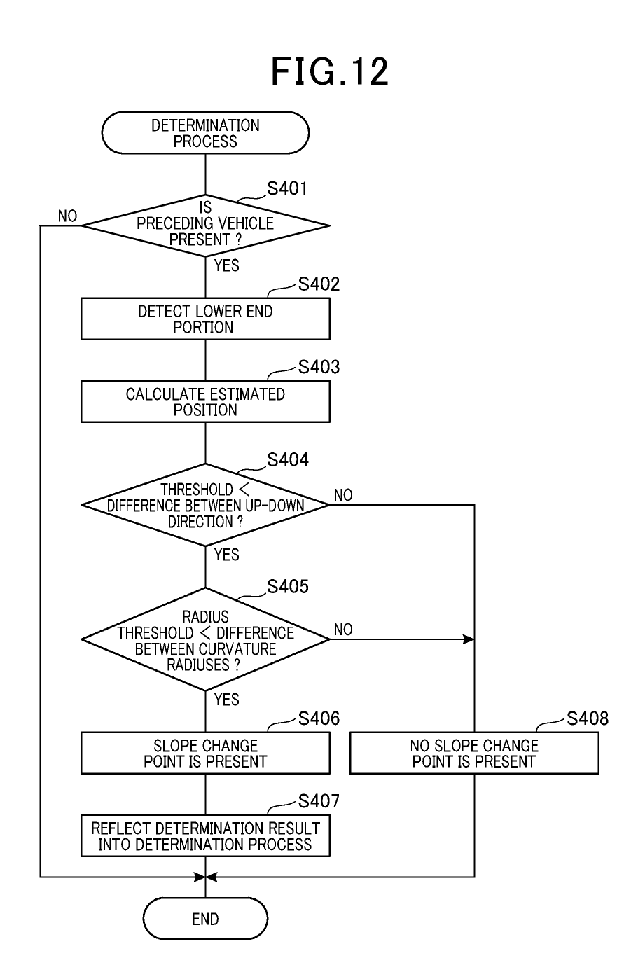

For example, according to the determination process of the second modification shown in FIG. 12, compared to the determination process of the first embodiment, a process at the step S405 is further added, in which the shape of the lane marking and the shape of the preceding vehicle are compared. That is, processes of steps S401 to S404, S406 to S408 are similar to the processes of steps S101 to S107. Hence, explanation of the processes of steps S401 to S404 and S406 to S408 will be omitted.

When it is determined that the difference between the lower end portion and the estimated portion of the preceding vehicle in the up-down direction exceeds the threshold, the road recognition apparatus 2 proceeds to step S405. At step S405, the road recognition apparatus 2 selects one side lane marking when only one side lane marking between the left and right lane markings of the vehicle 11 in the captured image is recognized, and selects either one lane marking when both side of the lane markings are recognized. Subsequently, the road recognition apparatus 2 detects the shape of the selected lane marking in the top view image, that is, inner edge of the selected lane marking in this example. Next, the road recognition apparatus 2 calculates the locus of the preceding vehicle in the top view image based on the location of the preceding vehicle in the plurality of images captured by the camera 1. Then, the road recognition apparatus 2 determines whether a difference between the radius of curvature of the inner edge of the lane marking and the radius of curvature of the locus of the preceding vehicle exceeds a predetermined radius threshold. Note that the radius threshold refers to an allowable limit value of the difference between both of the radiuses of the curvatures, where the shape of the lane marking and the locus of the preceding vehicle in the top view image can be determined as approximately the same. When it is determined that the difference between radiuses of the curvatures exceeds the radius threshold, the road recognition apparatus 2 proceeds to step S406. On the other hand, if the difference between the radiuses does not exceed the radius threshold, the road recognition apparatus 2 proceeds to step S408.

According to the above-described configuration, since a change in the slope is determined based on not only the difference of positions between the lower end portion and the estimated portion of the preceding vehicle in the captured image but also the difference between shapes of the lane marking and the locus in the top view image, the slope change can be determined with constant likelihood.

According to the determination process of the second modification, each of the difference between the lower end portion and the estimated portion of the preceding vehicle in the up-down direction calculated at step S404, and the difference between radiuses of the curvatures calculated at step S405, may be calculated as a reliability degree. Then, when the integrated value of these reliability degrees exceeds a predetermined threshold, the process may determine that the slope change point is present.

According to the determination process, the process may further determine, in the captured image, a difference between the location of the first vanishing point calculated based on the lower end portion of the left-right lane markings, and the location of the second vanishing point calculated based on the upper end portion of the left-right lane markings, thereby determining a slope change. The first vanishing point refers to a vanishing point identified based on the lane markings indicating the road in the vicinity of the vehicle 11, in accordance with a crossing point where lower end portions of the left-right lane markings in the captured image cross each other, that is, under an assumption where the road is flat having a constant slope. Meanwhile, the second vanishing point refers to a vanishing point corrected with respect to the first vanishing point, the second vanishing point being identified based on the upper end portions of the left-right markings in the captured image, that is, the lane markings in the actually captured image indicating the road in the distance. The second vanishing point is identified by, for example, a known method of detecting a vertical direction component in a plurality of direction edge components in a predetermined region of the captured image. Therefore, when the road is flat having a constant slope, the locations between the first vanishing point and the second vanishing point in the up-down direction are the same. On the other hand, when the slope of the road changes from a flat region having a constant slope, the locations between the first vanishing point and the second vanishing point in the up-down direction are different from each other.

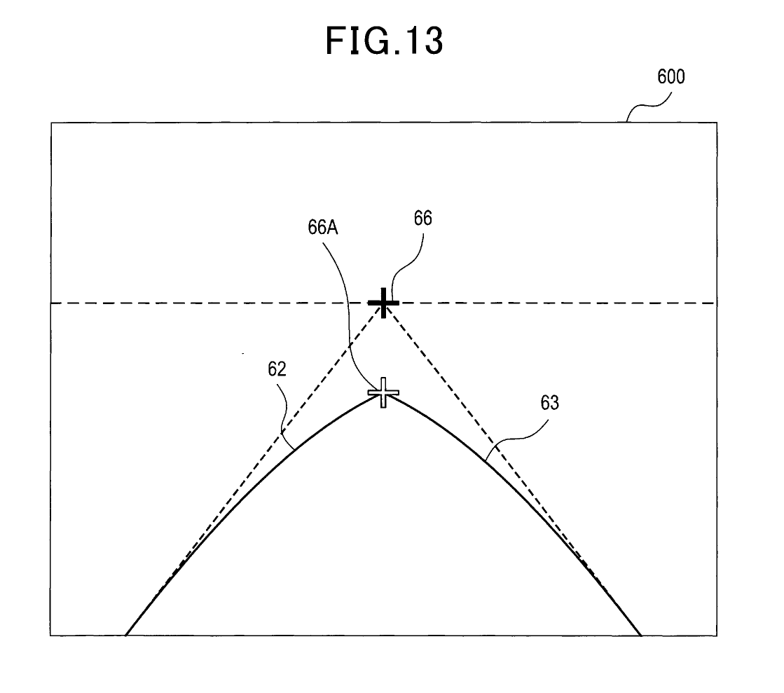

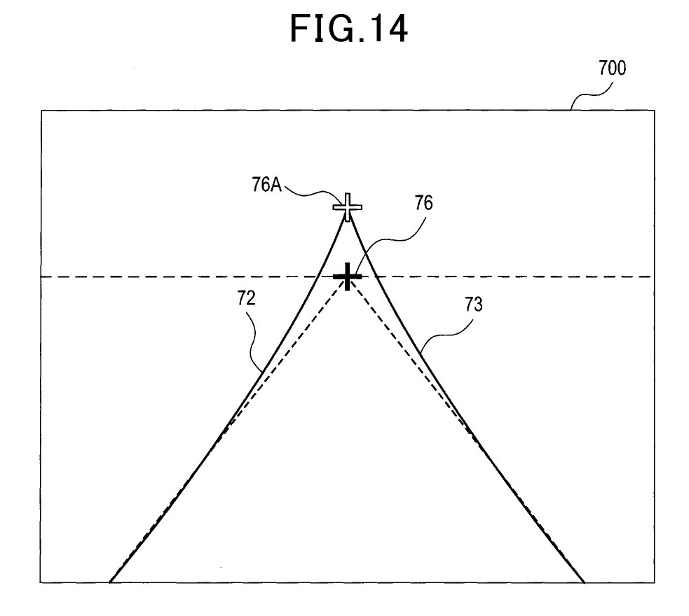

For example, the captured image 600 shown in FIG. 13 is an image capturing a road in which the slope changes from a flat region having a constant slope to a region having a downslope. The captured image 700 shown in FIG. 14 is an image capturing a road in which the slope changes from a flat region having a constant slope to a region having an upslope. In the captured image 600, the first vanishing point 66 is identified. In the captured image 700, the first vanishing point 76 is identified. Here, in the captured image 600, since the slope changes to the downslope from the slope change point, the upper end portions of the lane markings 62 and 63 cross each other in a portion located lower than the first vanishing point 66 and extending towards the center. Therefore, the second vanishing point 66A is identified at a portion lower than the first vanishing point 66. In the captured image 700, since the slope changes to the upslope from the slope change point, the upper end portions of the lane markings 72 and 73 cross each other in a portion located higher than the first vanishing point 76 and extending towards the center. Therefore, the second vanishing point 76A is identified at a portion higher than the first vanishing point 76.

Focusing on this point, when each of the difference between the lower end portion and the estimated portion of the preceding vehicle in the up-down direction, and the difference between the first vanishing point and the second vanishing point in the up-down direction exceeds a predetermined threshold, the process may determine that a slope change point is present.

According to the above-described configuration, since a change in the slope is determined using a positional change between the vanishing point and the corrected vanishing point in addition to the location of the preceding vehicle in the captured image, the slope change can be determined with constant likelihood.

According to the determination process of the third modification, each of the difference between the lower end portion and the estimated portion of the preceding vehicle in the up-down direction and the difference between the vanishing point and the corrected vanishing point may be calculated as a reliability degree, and when the integrated value of these reliability degrees exceeds a predetermined threshold, the process may determine that a slope change point is present.

A plurality of functions included in a single element of the above-described embodiments may be distributed a plurality of elements, or functions included in a plurality of elements may be integrated to one element. A part of configurations of the above-described embodiments can be replaced by known configuration. Also, a part of configurations of the above-described embodiments can be omitted as long as problems can be solved. At least part of the above-described configuration may be added to other configuration of the above-described embodiments, or may replace other configuration of the above-described embodiments. It should be noted that various aspects inherent in the technical ideas identified by the scope of claims are defined as embodiments of the present disclosure.

The present disclosure can be accomplished by various modes such as a system including the road recognition apparatus, a program having a computer serve as the road recognition apparatus, a recording media including the program stored therein, and a method for determination the slope change point, other than the above-described road recognition apparatus.

What is claimed is:

1. A road recognition apparatus comprising:
a detecting unit configured to detect a first position which is a position of a preceding vehicle in a captured image obtained by a camera mounted on a vehicle capturing ahead of a vehicle including a road;
a calculation unit configured to calculate a second position which is expected to be a position of the preceding vehicle in the captured image when assuming a slope of the road is constant; and
a determination unit configured to determine a change in the slope of the road by comparing the first position and the second position in the captured image.

2. The road recognition apparatus according to claim 1, wherein
the first position is a lower end portion of the preceding vehicle in the captured image; and
the second position is a lower end portion of the preceding vehicle in the captured image, when assuming that the road slope calculated based on a distance between the vehicle and the preceding vehicle is constant.

3. The road recognition apparatus according to claim 1, wherein
the first position is an upper end portion of the preceding vehicle in the captured image; and
the second position is a position of a vanishing point in the captured image when assuming that the road slope is constant.

4. The road recognition apparatus according to claim 1, wherein
the determination unit is configured to determine a change in the slope of the road based on a relative position between the first position and the second position in the up-down direction in the captured image.

5. The road recognition apparatus according to claim 1, wherein
the road recognition apparatus further comprises a recognition unit configured to recognize a lane marking in the captured image;
the determination unit is configured to determine whether a slope change point where a slope changes is present on the road; and
the recognition unit is configured to recognize the lane marking based on a region located lower than the slope change point in the captured image, when the determination unit determines that the slope change point is present.

6. The road recognition apparatus according to claim 1, wherein
the road recognition apparatus further comprises a recognition unit configured to recognize a lane marking in the captured image;
the determination unit is configured to determine whether a slope change point where a slope changes is present on the road; and
the recognition unit is configured not to recognize the lane marking in the captured image, when the determination unit determines that the slope change point is present.
